(19) United States
(12) Patent Application Publication
(10) Pub. No.: US 2026/0095643 A1
(43) Pub. Date: Apr. 2, 2026

(54) SELECTIVE ACTIVATION OF A CAMERA BASED ON SENSOR DATA

(71) Applicant: Apple Inc., Cupertino, CA (US)

(72) Inventors: Joshua J. Frost, Aptos, CA (US); Alexandria G. Heston, San Francisco, CA (US); Amrutha Hakkare Arunachala, Sunnyvale, CA (US); In Young Yang, Kirkland, WA (US); Magnus H. Johnson, San Francisco, CA (US); Yutaka Yokokawa, Los Gatos, CA (US)

(21) Appl. No.: 19/337,702

(22) Filed: Sep. 23, 2025

Related U.S. Application Data
(60) Provisional application No. 63/699,896, filed on Sep. 27, 2024.

(51) Int. Cl. H04N 23/611; G06T 7/70; H04N 23/62

(52) U.S. Cl. CPC H04N 23/611; G06T 7/70; H04N 23/62; G06T 2207/30201

(57) ABSTRACT

A method includes obtaining, via a sensor, sensor data indicative of a location of the device. The method includes obtaining, via a pose sensor, pose data indicating a pose of the device or a body part of a user of the device. The method includes activating a camera in response to the location satisfying a location criterion and the pose satisfying a pose criterion.

### CROSS-REFERENCE TO RELATED APPLICATIONS

This application claims priority to U.S. Provisional Patent App. No. 63/699,896, filed on Sep. 27, 2024, which is hereby incorporated by reference in its entirety.

### TECHNICAL FIELD

The present disclosure generally relates to selective activation of a camera based on sensor data.

### BACKGROUND

Some devices include a camera. Some devices continuously keep the camera on in order to capture images of a physical environment of the device. Cameras can be resource-intensive. For example, continuously keeping the camera active can drain a battery of the device. Moreover, capturing excessive amounts of image data can reduce an amount of storage that is available for other operations.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1E are diagrams of an example environment in accordance with some implementations.

FIG. 2 is a block diagram of a system that controls activation of a camera in accordance with some implementations.

FIG. 3 is a flowchart representation of a method of controlling activation of a camera in accordance with some implementations.

FIG. 4 is a block diagram of a device that controls activation of a camera in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for selectively activating a camera based on sensor data. In some implementations, a device includes a camera, a sensor, one or more processors and a non-transitory memory. In various implementations, a method includes obtaining, via the sensor, sensor data indicative of a location of the device. In some implementations, the method includes obtaining, via a pose sensor, pose data indicating a pose of the device or a body part of a user of the device. In some implementations, the method includes activating the camera in response to the location satisfying a location criterion and the pose satisfying a pose criterion.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some devices include a camera for capturing images of a physical environment of the device. The device can utilize the captured images for a variety of operations. For example, the device can utilize the images to anticipate needs of a user and automatically control physical objects without requiring user input. For example, the device can unlock a door lock when the user reaches for a door knob thereby reducing the need for the user to unlock the door lock with a key or via an application on the device. However, keeping the camera on at all times may be undesirable. Furthermore, keeping the camera on for an extended duration of time can drain a battery of the device.

The present disclosure provides methods, systems, and/or devices for selectively activating a camera of a device. The device turns on the camera to capture images when a camera activation criterion is satisfied. Otherwise, the device maintains the camera in an off state. The device turns the camera on based on a location, and a pose of the device or a user of the device. Turning the camera on when the location and the pose indicate that images from the camera are needed to perform an action tends to prolong a battery life of the device.

As an example, the device turns the camera on when a current location of the device is near a locked door and the pose indicates that the user is looking down towards a door knob or reaching for the door knob. In this example, turning on the camera allows the device to first confirm that the user is at the door and then unlock the door for the user by sending an unlock command to the lock. Advantageously, the device conserves power and memory by keeping the camera off until the location of the device is near the door and the pose of the user indicates that the user is likely looking at the door or reaching for the door knob. Keeping the camera off improves a functionality of the device because conserving power allows the device to operate for a longer time duration and conserving memory prevents memory overruns.

As another example, the device turns the camera on when a current location is a room with motorized blinds and the pose indicates that the user is looking up towards a top of the blinds when the blinds are open or down towards a bottom of the blinds when the blinds are closed. In this example, turning the camera on allows the device to confirm that the user is looking at the blinds and likely wants to open or close the blinds. After confirming that the user is looking at the blinds, the device can send a command to open or close the blinds. Advantageously, the device conserves power and memory by keeping the camera off until the location of the device is proximate to the blinds and the pose of the user indicates that the user is likely looking at the blinds. Reducing an amount of time that the camera is kept on improves a functionality of the device because reducing power usage prolongs a battery life of the device and reducing memory usage leaves more memory for other operations.

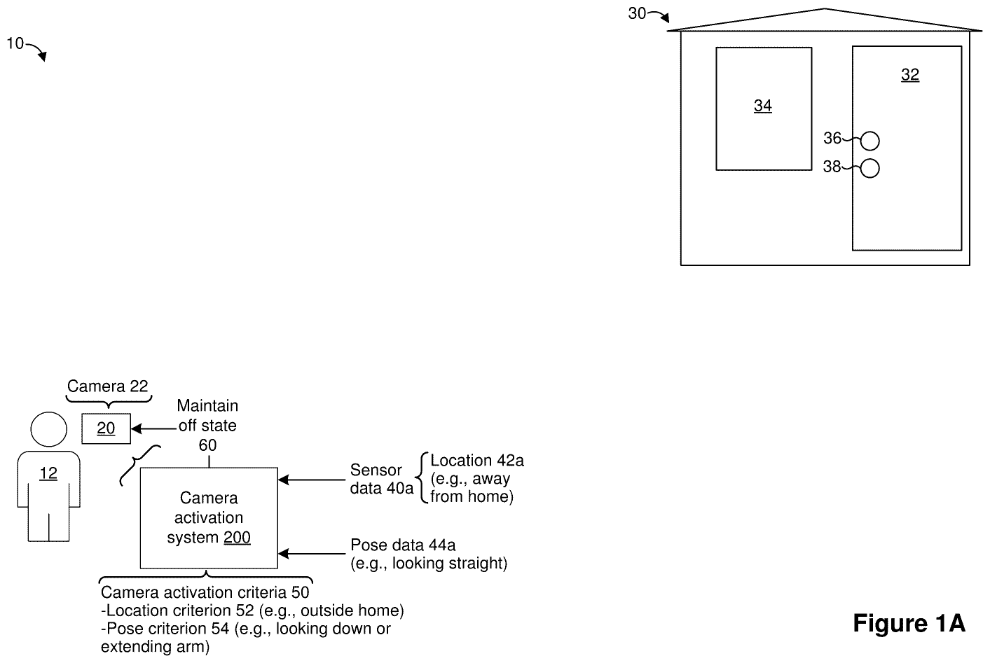

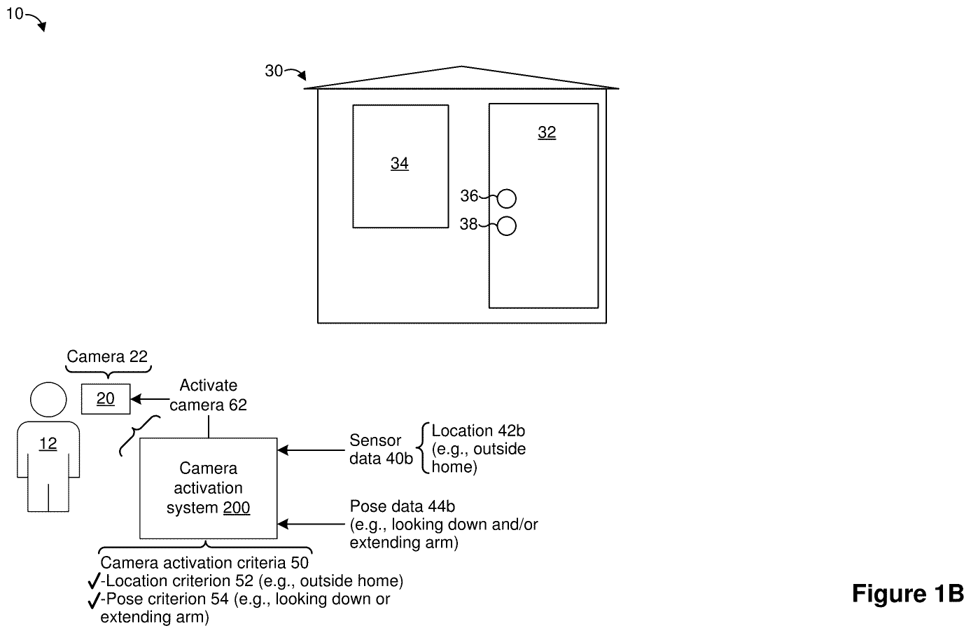

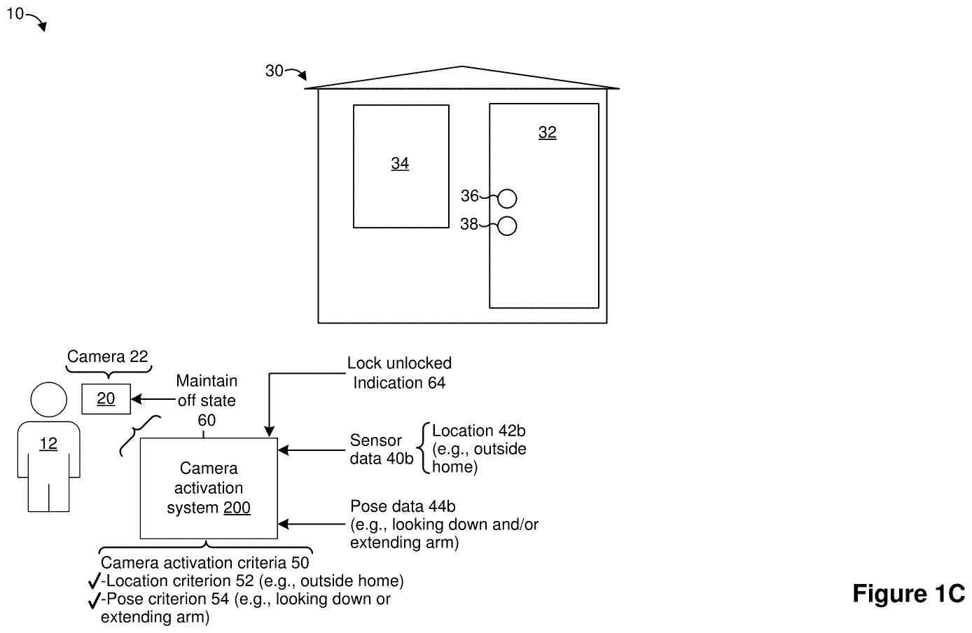

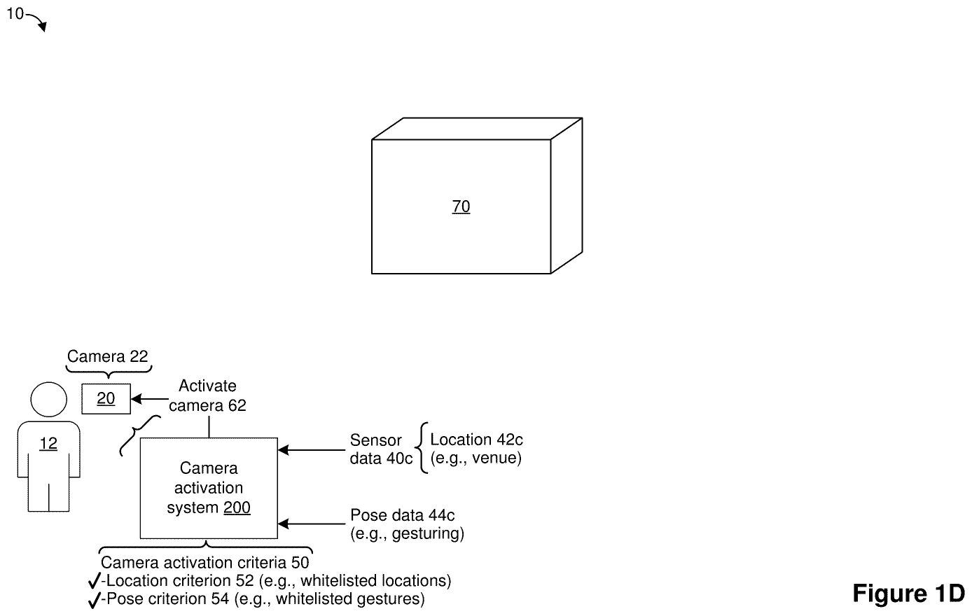

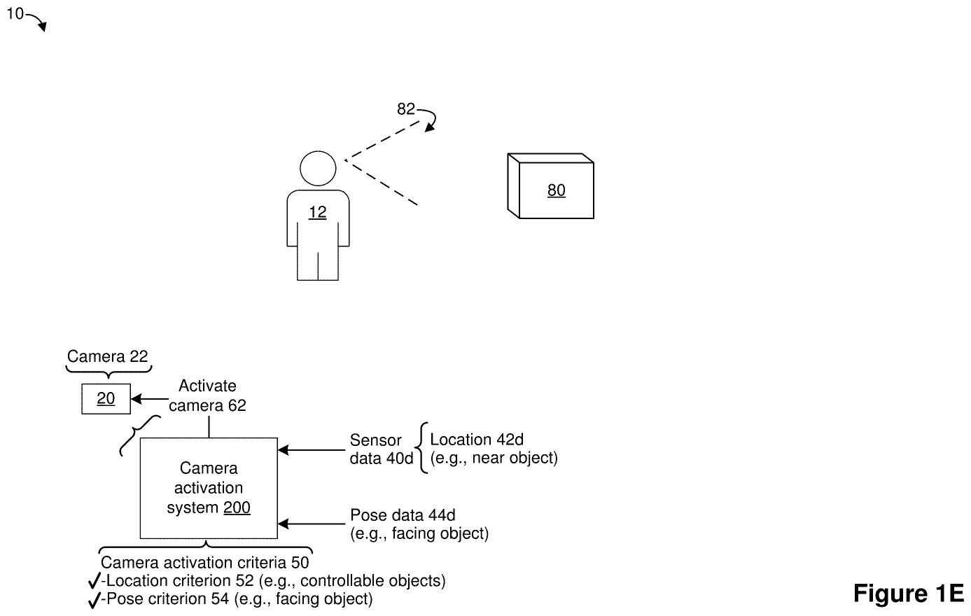

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) with a camera 22, and a camera activation system 200 for controlling activation of the camera 22. In some implementations, the camera activation system 200 resides at the device 20. Alternatively, in some implementations, the camera activation system 200 resides at another device that is in electronic communication with the device 20. For example, the device 20 includes a head-mountable device (HMD) and the camera activation system 200 resides at a smartphone that is wirelessly connected with the HMD.

In the example of FIG. 1A, the physical environment 10 further includes a home 30 of the user 12. The home 30 includes a door 32, a window 34, a lock 36 and a door knob 38. In some implementations, the device 20 can wirelessly transmit a command to the lock 36 to switch the lock 36 between a locked position and an unlocked position. In some implementations, the device 20 transmits an unlock command to the lock 36 when images captured by the camera 22 include a representation of the lock 36. In some implementations, the device 20 transmits the unlock command to the lock 36 when the images captured by the camera 22 indicate that the user 12 is at the door 32 and wants to enter the building 30. In some implementations, the device 20 utilizes image data captured by the camera 22 to confirm that the device 20 is near the door 32 before switching the lock 36 from a locked position to an unlocked position. Confirming that the device 20 is near the door 32 prevents inadvertently unlocking the door 32 when the user 12 is not near the home 30. However, the device 20 keeps the camera 22 off until sensor data captured by other low-powered sensors (e.g., sensors that consume less power than the camera 22) indicate that the device 20 is near the home 30 and the user 12 likely intends to open the door 32. Using low-powered sensors to determine when to power on the camera 22 tends to reduce an amount of time that the camera 22 is kept on thereby conserving power and prolonging a battery of the device 20.

In various implementations, the camera activation system 200 obtains first sensor data 40a that indicates a first location 42a of the device 20 at a first time, and first pose data 44a that indicates a first pose of the device 20 or the user 12 at the first time. The camera activation system 200 determines whether the first sensor data 40a and the first pose data 44a satisfy camera activation criteria 50 for activating (e.g., turning on) the camera 22. In some implementations, the camera activation criteria 50 includes a location criterion 52 and a pose criterion 54. In the example of FIG. 1A, the location criterion 52 is satisfied when the device 20 is immediately outside the home 30 (e.g., within a threshold distance of the home 30, for example, within 5 feet of the door 32). The pose criterion 54 is satisfied when the user 12 is looking down towards the door knob 38 or extending his/her arm to reach for the door knob 38.

In the example of FIG. 1A, the location criterion 52 is not satisfied because the first location 42a of the device 20 is away from the home 30 (e.g., more than a threshold distance from the home 30, for example, a few miles from the home 30). In the example of FIG. 1A, the pose criterion 54 is not satisfied because the first pose data 44a indicates the user 12 is looking straight, for example, because the user 12 is walking towards the home 30. Since the first location 42a does not satisfy the location criterion 52 and the first pose data 44a does not satisfy the pose criterion 54, the camera activation system 200 sends a maintain instruction 60 to the device 20 instructing the device 20 to maintain the camera 22 in an off state in order to conserve battery.

Referring to FIG. 1B, the camera activation system 200 obtains second sensor data 40b that indicates a second location 42b of the device 20 at a second time that occurs after the first time, and second pose data 44b that indicates a second pose of the device 20 or the user 12 at the second time. The camera activation system 200 determines whether the second sensor data 40b and the second pose data 44b satisfy the camera activation criteria 50 for activating (e.g., turning on) the camera 22. As indicated by a checkmark adjacent to the location criterion 52, the location criterion 52 is satisfied because the second location 42b of the device 20 is within a threshold distance of the door 32 (e.g., within 5 feet of the door 32). As indicated by a checkmark adjacent to the pose criterion 54, the pose criterion 54 is satisfied because the second pose data 44b indicates that the user 12 is looking downwards or extending his/her arm to reach for something. Since the second location 42b satisfies the location criterion 52 and the second pose data 44b satisfies the pose criterion 54, the camera activation system 200 sends an activate instruction 62 to the device 20 instructing the device 20 to turn on the camera 22.

In the example of FIG. 1B, turning the camera 22 on when the device 20 is proximate to the door 32 and the user 12 is gazing downwards or reaching for something allows the device 20 to capture image data that confirms that the user 12 is gazing at the door knob 38 and/or reaching for the door knob 38. After confirming that the user 12 intends to open the door 32, the device 20 can transmit an unlock command to the lock 36 thereby preventing the need for the user 12 to insert a physical key into a key hole of the lock 36 or open an application on the device 20 to unlock the lock 36. Maintaining the camera 22 in the off state until the location criterion 52 and the pose criterion 54 are satisfied conserves a battery of the device 20 thereby improving an operability of the device 20 by allowing the user 12 to use the device 20 for an extended time duration.

Turning the camera 22 on when the location criterion 52 and the pose criterion 54 are concurrently satisfied tends to result in increased resource conservation than turning the camera 22 on when only the location criterion 52 is satisfied or only the pose criterion 54 is satisfied. As an example, the user 12 may arrive at the home 30 but may spend several minutes outside the home 30 while the user 12 finishes a work phone call. In this example, the location criterion 52 is satisfied when the user 12 arrives at the home 30 but the pose criterion 54 may not be satisfied while the user 12 finishes the work phone call. As such, turning the camera 22 on based solely on the location criterion 52 being satisfied unnecessarily drains a battery of the device 20 while the user 12 finishes the work phone call. However, turning the camera 22 on when the location criterion 52 and the pose criterion 54 are concurrently satisfied reduces an amount of time that the camera 22 is kept on thereby conserving power and/or memory resources.

Referring to FIG. 1C, the camera activation system 200 receives a lock unlocked indication 64 indicating that the lock 36 is currently in an unlocked position. Since the lock 36 is already unlocked, the device 20 does not require image data captured by the camera 22 to confirm whether the user 12 intends to open the door 32. As such, in the example of FIG. 1C, the camera activation system 22 transmits the maintain instruction 60 instead of the activate instruction 62 shown in FIG. 1B. As such, the device 20 maintains the camera 22 in the off state and conserves battery. In some implementations, the camera activation system 200 receives the lock unlocked indication 64 from a hub that gathers status data from various controllable objects such as the lock 36, the window 34, window shades that cover the window 34, lights in the home 30, etc.

Referring to FIG. 1D, the camera activation system 200 obtains third sensor data 40c that indicates a third location 42c of the device 20, and third pose data 44c that indicates a third pose of the device 20 or the user 12. The camera activation system 200 determines whether the third sensor data 40c and the third pose data 44c satisfy the camera activation criteria 50 for activating (e.g., turning on) the camera 22. In the example of FIG. 1D, the third location 42c is a venue 70 such as a monument or a concert hall. The third pose data 44c indicates that the user 12 is gesturing. As an example, the third pose includes a head gesture such as the user 12 bobbing his/her head to music being played at the venue 70. As another example, the third pose includes a whole body pose of the user 12 such as the user 12 dancing to music being played at the venue 70. As another example, the third pose includes a hand gesture such as the user 12 making a picture-taking gesture with his/her hands at the venue 70.

In the example of FIG. 1D, the location criterion 52 is associated with a set of one or more locations (e.g., a set of whitelisted locations, for example, a set of permissible locations). The location criterion 52 is satisfied when the third location 42c is among the set of one or more locations specified by the location criterion 52. As an example, the location criterion 52 may specify that venues satisfy the location criterion 52 (e.g., certain types of venues such as concert halls, monuments or auditoriums satisfy the location criterion 52). As indicated by the checkmark adjacent to the location criterion 52, the third location 42c satisfies the location criterion 52, for example, because the third location 42c is among the set of one or more locations associated with the location criterion 52 (e.g., because the third location 42c is among the set of whitelisted locations and not among a set of blacklisted/impermissible locations).

In the example of FIG. 1D, the pose criterion 54 is associated with a set of one or more poses (e.g., a set of whitelisted poses, for example, a set of permissible poses). The pose criterion 54 is satisfied when the third pose is among the set of one or more poses specified by the pose criterion 54. As an example, the pose criterion 54 may specify that certain head gestures (e.g., bobbing of the head), certain hand gestures (e.g., making a picture-taking gesture) and certain whole body poses (e.g., dancing, jumping, etc.) satisfy the pose criterion 54. As indicated by the checkmark adjacent to the pose criterion 54, the third pose satisfies the pose criterion 54, for example, because the third pose is among the set of one or more poses associated with the pose criterion 54.

Since the third location 42c satisfies the location criterion 52 and the third pose data 44c satisfies the pose criterion 54, the camera activation system 200 sends an activate instruction 62 to the device 20 instructing the device 20 to turn on the camera 22. In some implementations, the camera 22 automatically starts recording a video or taking pictures so that the user 12 does not need to press a capture button within a camera GUI. In some implementations, the device 20 displays the camera GUI with a stop button that the user 12 can press so stop the video recording. In some implementations, after activating the camera 22, the camera activation system 200 can deactivate the camera 22 when a subsequent location does not satisfy the location criterion 52 or a subsequent pose does not satisfy the pose criterion 54. As such, the camera 22 does not unnecessarily stay on for a prolonged period.

Referring to FIG. 1E, the camera activation system 200 obtains fourth sensor data 40d that indicates a fourth location 42d of the device 20, and fourth pose data 44d that indicates a fourth pose of the device 20 or the user 12. The camera activation system 200 determines whether the fourth sensor data 40d and the fourth pose data 44d satisfy the camera activation criteria 50 for activating (e.g., turning on) the camera 22. In the example of FIG. 1E, the fourth location 42d corresponds to a location of a controllable object 80 such as the window 34 shown in FIGS. 1A and 1B. The fourth pose data 44d indicates an orientation of the user 12. For example, the fourth pose data 44d indicates that the user 12 is facing in a direction of the controllable object 80. As another example, the fourth pose data 44d indicates that an estimated view frustum 80 of the camera 22 is directed to the controllable object 80. For example, the controllable object 80 is within the estimated view frustum 82 of the camera 22.

In the example of FIG. 1E, the location criterion 52 is associated with a set of one or more controllable objects. For example, the location criterion 52 specifies locations of the controllable objects. The location criterion 52 is satisfied when the fourth location 42d is within a threshold distance of one of the controllable objects associated with the location criterion 52. As an example, the location criterion 52 may specify that being in the same room as a motorized window shade satisfies the location criterion 52. As indicated by the checkmark adjacent to the location criterion 52, the fourth location 42d satisfies the location criterion 52, for example, because the fourth location 42d is within a threshold distance of the controllable object 80.

In the example of FIG. 1E, the pose criterion 54 is associated with a set of one or orientations for the device 20 or the user 12. The pose criterion 54 is satisfied when the fourth pose indicates an orientation that matches one of the device orientations or user orientations specified by the pose criterion 54. As an example, the pose criterion 54 specifies that the user 12 facing one of the controllable objects identified by the location criterion 52 satisfies the pose criterion 52. As another example, the pose criterion 54 specifies that one of the controllable objects being in the estimated view frustum 82 of the camera 22 satisfies the pose criterion 54. As indicated by the checkmark adjacent to the pose criterion 54, the fourth pose satisfies the pose criterion 54, for example, because the estimated view frustum 82 includes the controllable object 80.

Since the fourth location 42d satisfies the location criterion 52 and the fourth pose data 44d satisfies the pose criterion 54, the camera activation system 200 sends an activate instruction 62 to the device 20 instructing the device 20 to turn on the camera 22. Upon receiving the activate instruction 62, the device 20 turns the camera 22 on in order to start capturing image data. The image data captured by the camera 22 confirms that the user 12 is facing the controllable object 80. As such, after turning the camera 22 on, the device 20 detects gestures performed by the user 12 and controls the controllable object 80 based on the gestures performed by the user 12. In some implementations, after activating the camera 22, the camera activation system 200 can deactivate the camera 22 when a subsequent location does not satisfy the location criterion 52 (e.g., when the user 12 leaves the room where the controllable object 80 is located) or a subsequent pose does not satisfy the pose criterion 54 (e.g., when the user 12 turns away from the controllable object 80). As such, the camera 22 does not unnecessarily stay on for a prolonged period.

In some implementations, the camera activation system 200 associates the activate instruction 60 with a time period. In such implementations, the camera activation system 200 instructs the device 20 to turn on the camera 22 for the time period associated with the activate instruction 60. The time period may vary based on the detected location and the detected pose. As an example, referring to FIG. 1B, the time period for confirming that the user 12 is at the door 32 may be relatively short (e.g., less than 5 seconds). By contrast, referring to FIG. 1D, the time period for confirming that the user 12 is at the venue 70 and automatically capturing pictures at the venue 70 may be longer (e.g., 30 seconds). Furthermore, the time period for detecting gestures may be shorter than a time period for recording videos. For example, the time period for detecting a gesture to control the controllable object 80 shown in FIG. 1E may be shorter than a time period for capturing video at the venue 70 shown in FIG. 1D. Turning the camera off after the time period associated with the activate instruction 60 expires tends to conserve battery by limiting an amount of time that the camera 22 is kept on.

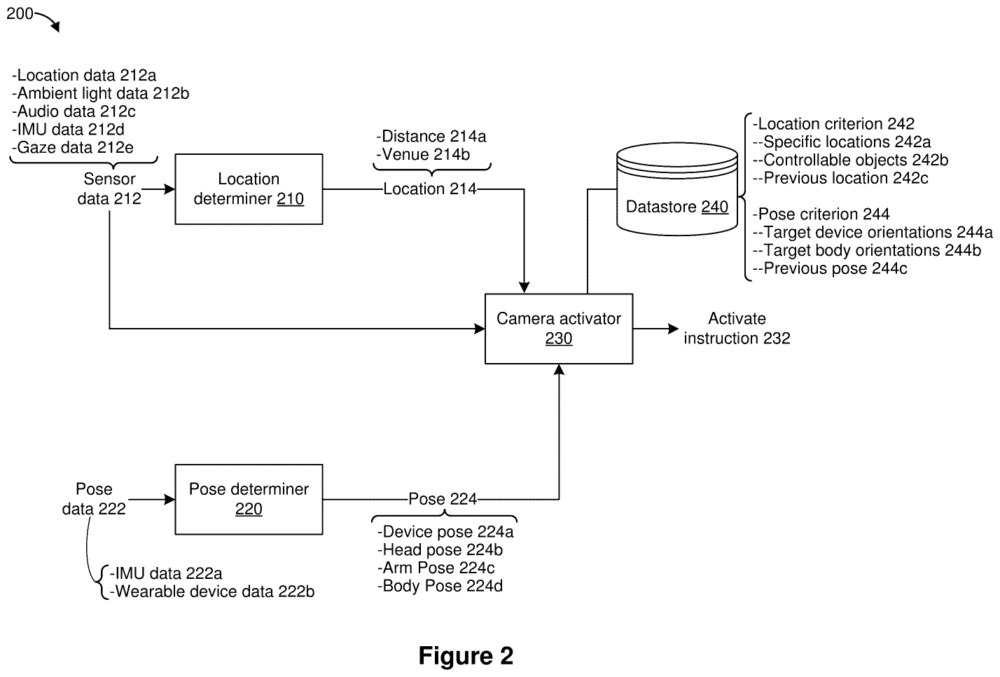

FIG. 2 is a block diagram of the system 200 in accordance with some implementations. In some implementations, the system 200 includes a location determiner 210, a pose determiner 220 and a camera activator 230.

In various implementations, the location determiner 210 obtains sensor data 212 and utilizes the sensor data 212 to determine a location 214 of a device or a user of the device. For example, referring to FIG. 1A, the location determiner 210 determines the first location 42a based on the first sensor data 40a. In some implementations, the location determiner 210 obtains (e.g., receives) the sensor data 212 from a single device (e.g., the device 20 shown in FIGS. 1A-1E). Alternatively, in some implementations, the location determiner 210 obtains the sensor data 212 from multiple devices. For example, the location determiner 210 receives a portion of the sensor data 212 from a handheld computing device such as a smartphone or a tablet, and another portion of the sensor data 212 from a wearable computing device such as an HMD or an electronic watch.

In some implementations, the sensor data 212 includes location data 212a from a location sensor (e.g., latitude and longitudinal coordinates from a Global Positioning System (GPS)). In some implementations, the location data 212a indicates a distance 214a of the device or the user from a controllable object. For example, referring to FIG. 1A, the location data 212a indicates a distance of the device 20 from the door 32 with the lock 36. In some implementations, the location data 212a indicates a venue 214b where the device is located (e.g., the venue 70 shown in FIG. 1D).

In some implementations, the sensor data 212 includes ambient light data 212b obtained from an ambient light sensor (ALS), and the location determiner 210 determines the location 214 based on the ambient light data 212b. Different locations may be associated with respective ambient light signatures. For example, referring to FIG. 1B, a location immediately outside the door 32 may be associated with a particular ambient light signature due to a combination of light emitted by a bulb adjacent to the door 32 and natural daylight. In this example, when the ambient light data 212b matches the ambient light signature associated with the location immediately outside the door 32, the location determiner 210 determines that the device is likely outside the door 32.

In some implementations, the sensor data 212 includes audio data 212c obtained from a microphone, and the location determiner 210 determines the location 214 based on the audio data 212c. Different locations may be associated with respective audio signatures. For example, referring to FIG. 1D, the venue 70 may be associated with a specific acoustic characteristic (e.g., known reverberation levels, known amplitude range and/or known frequency range). In this example, when the audio data 212c matches the specific acoustic characteristic associated with the venue 70, the location determiner 210 determines that the device is located at the venue 70.

In some implementations, the sensor data 212 includes inertial measurement unit (IMU) data 212d obtained from an IMU, and the location determiner 210 determines the location 214 based on the IMU data 212d. In some implementations, the location determiner 210 determines the location 214 based on a previously-known location of the device provided by a location sensor and the IMU data 212d collected subsequent to the previously-known location reported by the location sensor. For example, the location determiner 210 adjusts the previously-known location based on device movements indicated by the IMU data 212d. In some implementations, some locations are associated with respective magnetic field signatures. In such implementations, the location determiner 210 determines the location 214 based on a comparison between current magnetic field data and the magnetic field signatures.

In some implementations, the sensor data 212 includes gaze data 212e obtained from an eye tracker, and the location determiner 210 determines the location 214 based on the gaze data 212e. Different locations may trigger different gaze responses from the user. As an example, referring to FIGS. 1A and 1B, as the user 12 approaches the home 30 in FIG. 1B the gaze data 212e may indicate a gaze response that the user 12 exhibits upon reaching the home 30 (e.g., widening of the eyes, dilating of the pupils, etc.). In the example of FIGS. 1A and 1B, when the gaze data 212e matches a gaze response associated with arriving at the home 30, the location determiner 210 determines that the device 20 has arrived at the door 32 of the home 30.

In some implementations, the pose determiner 220 obtains pose data 222 and utilizes the pose data 222 to determine a pose 224 of the device or the user of the device. In some implementations, the pose data 222 includes IMU data 222a captured by an IMU. For example, referring to FIGS. 1A-1E, the pose determiner 220 receives the IMU data 222a from an IMU integrated into the device 20. In some implementations, the pose data 2220 includes wearable device data 222b captured by a wearable computing device such as an electronic watch or an HMD. In some implementations, the wearable device data 222b is captured by an IMU that resides within the wearable computing device.

In some implementations, the pose 224 includes a device pose 224a. In some implementations, the device pose 224a indicates an orientation of the device 20 (shown in FIGS. 1A-1E) about an axis. For example, the device pose 224a includes a set of three angle values that represent rotations around respective axes. As an example, the device pose 224a includes a pitch value that defines a rotation of the device 20 around an x-axis, a yaw value that defines a rotation of the device 20 around a y-axis and a roll value that defines a rotation of the device 20 around a z-axis.

In some implementations, the pose 224 includes a head pose 224b. In some implementations, the head pose 224b indicates an orientation of a head of the user 12 (shown in FIGS. 1A-1E) about an axis. For example, the head pose 224b includes a set of three angle values that represent rotations around respective axes. As an example, the head pose 224b includes a pitch value that defines a rotation of the head around an x-axis, a yaw value that defines a rotation of the head around a y-axis and a roll value that defines a rotation of the head around a z-axis. In some implementations, the head pose 224b indicates a head gesture being performed by the user 12. For example, referring to FIG. 1D, the head pose 224b indicates that the user 12 is bobbing his/her head to music that may be playing at the venue 70.

In some implementations, the pose 224 includes an arm pose 224c. In some implementations, the arm pose 224c indicates an orientation of an arm of the user 12 (shown in FIGS. 1A-1E) about an axis. For example, the arm pose 224c includes a set of three angle values that represent rotations around respective axes. As an example, the arm pose 224c includes a pitch value that defines a rotation of the arm around an x-axis, a yaw value that defines a rotation of the arm around a y-axis and a roll value that defines a rotation of the arm around a z-axis. In some implementations, the arm pose 224c indicates whether the arm is extended away from the user 12 (e.g., to reach the door knob 38 shown in FIGS. 1A and 1B). In some implementations, the arm pose 224c indicates a hand gesture being performed by the user 12. For example, referring to FIG. 1D, the arm pose 224c indicates that the user 12 is making a picture-taking gesture with his/her hands at the venue 70.

In some implementations, the pose 224 includes a body pose 224d that characterizes a movement of the body of the user 12 as a whole. In some implementations, the body pose 224d indicates an action that the user 12 is currently performing. For example, referring to FIG. 1D, the body pose 224d indicates that the user 12 is dancing. As another example, referring to FIG. 1B, the body pose 224d indicates that the user 12 is looking down and reaching for something with his/her arm. As another example, referring to FIG. 1D, the body pose 224d indicates that the user 12 is making a picture-taking gesture with his/her hands. As yet another example, referring to FIG. 1E, the body pose 224d indicates that the user 12 is looking straight.

In various implementations, the camera activator 230 provides an activate instruction 232 (e.g., the activate instruction 60 shown in FIGS. 1B, 1D and 1E) based on an evaluation of the location 214 and the pose 224. In some implementations, a datastore 240 stores location criterion 242 (e.g., the location criterion 52 shown in FIGS. 1A-1E) and pose criterion 244 (e.g., the pose criterion 54 shown in FIGS. 1A-1E). In such implementations, the camera activator 230 provides the activate instruction 232 in response to the location 214 satisfying the location criterion 242 and the pose 224 satisfying the pose criterion 244.

In some implementations, the location criterion 242 indicates specific locations 242a. In some implementations, the specific locations 242a may include whitelisted locations (e.g., permissible locations) where the camera 22 of the device 20 can be turned on. In such implementations, the camera activator 230 determines that the location criterion 242 is satisfied when the location 214 (e.g., the venue 214b) is among the whitelisted locations. By contrast, in such implementations, the camera activator 230 determines that the location criterion 242 is not satisfied when the location 214 (e.g., the venue 214b) is not among the whitelisted locations. Additionally or alternatively, in some implementations, the specific locations 242a may include blacklisted locations (e.g., impermissible locations) where the camera 22 of the device 20 is not to be turned on. In such implementations, the camera activator 230 determines that the location criterion 242 is satisfied when the location 214 (e.g., the venue 214b) is not among the blacklisted locations. By contrast, in such implementations, the camera activator 230 determines that the location criterion 242 is not satisfied when the location 214 (e.g., the venue 214b) is among the blacklisted locations.

In some implementations, the location criterion 242 indicates controllable objects 242b that can electronically be switched between states. An example of the controllable objects 242b is the lock 36 shown in FIGS. 1A and 1B that can be moved between a locked position and an unlocked position by sending a command to a controller that controls the position of the lock 36. Another example of the controllable objects 242b is the window 34 shown in FIGS. 1A and 1B that can be slid between an open position and a closed position by sending a command to an actuator that applies a force on the window 34. Yet another example of the controllable objects 242b is the controllable object 80 shown in FIG. 1E that the device 20 controls by sending control commands. In some implementations, the location criterion 242 includes geographical locations of the controllable objects 242b. In such implementations, the camera activator 230 determines that the location criterion 242 is satisfied when the location 214 is within a threshold distance of one of the controllable objects 242b (e.g., when the distance 214a between the device and one of the controllable objects 242b is less than the threshold distance). By contrast, the camera activator 230 determines that the location criterion 242 is not satisfied when the location 214 is not within the threshold distance of any of the controllable objects 242b (e.g., when the distance 214a between the device and each of the controllable objects 242 is greater than the threshold distance).

In some implementations, the location criterion 242 is associated with a previous location 242c of the device. The previous location 242c represents a location that the location determiner 210 determined at a previous time (e.g., more than a threshold amount of time prior to a current time, for example, 10 minutes ago). In such implementations, the location criterion 242 is satisfied when a difference between the location 214 and the previous location 242c is greater than a threshold.

In some implementations, the pose criterion 244 indicates target device orientations 244a. The target device orientations 244a may include target yaw, pitch and roll values. In some implementations, the camera activator 230 determines that the pose criterion 244 is satisfied when the device pose 224a indicates a device orientation that matches one of the target device orientations 244a.

In some implementations, the pose criterion 244 indicates target body orientations 244b for a head of the user, an arm of the user or the body of the user as a whole. The target body orientations 244b may include target yaw, pitch and roll values for the head and/or the arm. Additionally or alternatively, the target body orientations 244b may include certain actions such as dancing, gesturing with hands (e.g., making a picture-taking gesture), bobbing head, etc. In some implementations, the camera activator 230 determines that the pose criterion 244 is satisfied when the head pose 224b, the arm pose 224c or the body pose 224d indicates a pose that matches one of the target body orientations 244b.

In some implementations, the pose criterion 244 is associated with a previous pose 244c of the device or the user. The previous pose 244c represents a pose that the pose determiner 220 determined at a previous time (e.g., more than a threshold amount of time prior to a current time, for example, 10 minutes ago). In such implementations, the pose criterion 244 is satisfied when a difference between the pose 224 and the previous pose 244c is greater than a threshold.

In some implementations, after providing the activate instruction 232, the camera activator 230 recalls the activate instruction 232 or provides a deactivate instruction when a subsequent location does not satisfy the location criterion 242 or a subsequent pose does not satisfy the pose criterion 244. As such, the camera activator 230 maintains the camera in an on state while the location criterion 242 and the pose criterion 244 are concurrently satisfied, and the camera activator 230 switches the camera off when either one of the location criterion 242 or the pose criterion 244 are not satisfied.

In some implementations, the camera activator 230 obtains the sensor data 212, and the camera activator 230 determines whether to provide the activate instruction 232 based further on the sensor data 230. For example, in some implementations, the camera activator 230 determines whether to turn on the camera based further on the gaze data 212e satisfying a gaze criterion. As an example, the camera activator 230 determines whether a gaze of the user is fixated at a particular location for more than a threshold amount of time. In this example, a fixated gaze may indicate that the user is looking at an object of interest. As such, the camera activator 230 turns the camera on in order to identify the object and provide an option to control the object using camera-tracked gestures.

In some implementations, the sensor data 212 indicates a status of an object that can be switched between two or more states. For example, the sensor data 212 indicates whether the lock 36 shown in FIGS. 1A and 1B is in a locked position or an unlocked position. In some implementations, the camera activator 230 determines whether to turn on the camera based further on the status of the object. As an example, referring to FIG. 1C, if the lock 36 is already unlocked, the camera activator 230 may leave the camera in the off state even though the location criterion 252 and the pose criterion 254 have been satisfied.

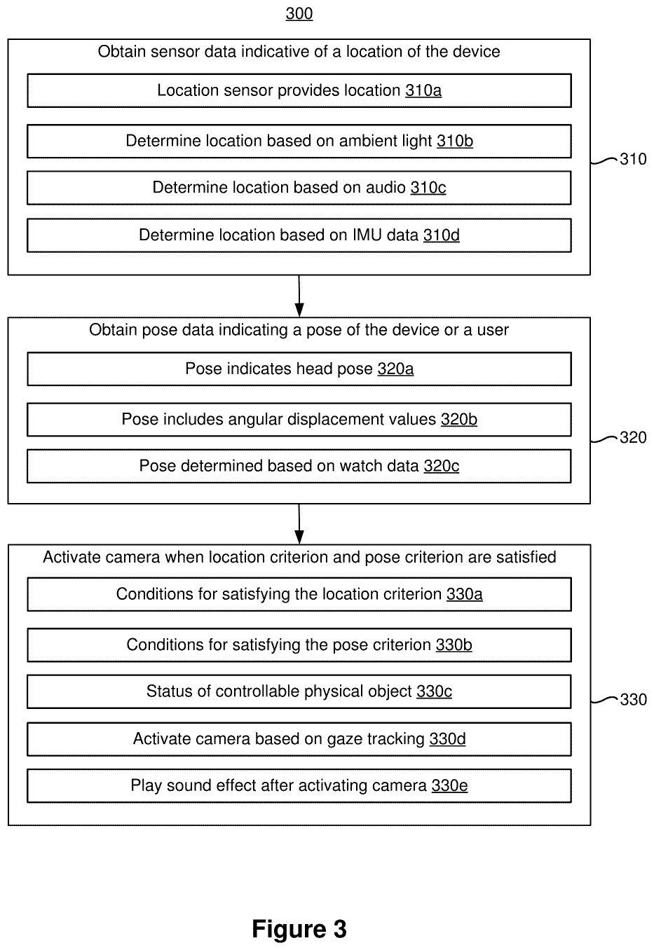

FIG. 3 is a flowchart representation of a method 300 for controlling activation of a camera. In various implementations, the method 300 is performed by a device including a camera, a sensor, a non-transitory memory and one or more processors coupled with the camera, the sensor and the non-transitory memory (e.g., the device 20 shown in FIGS. 1A-1E and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes obtaining, via the sensor, sensor data indicative of a location of the device. For example, as shown in FIG. 1A, the camera activation system 200 receives the first sensor data 40a indicative of the first location 42a of the device 20 at a first time. As represented by block 310a, in some implementations, the sensor includes a location sensor and the sensor data includes location data captured by the location sensor. For example, as shown in FIG. 2, the sensor data 212 includes the location data 212a. In some implementations, the sensor includes a receiver that receives location data from another device including a location sensor that captured the location data. For example, referring to FIGS. 1A-1E, the device 20 receives the location data from another device such as an electronic watch that the user 12 is wearing on his/her wrist.

As represented by block 310b, in some implementations, the sensor includes an ambient light sensor (ALS), the sensor data includes an ambient lighting level captured by the ALS, and the device determines the location based on the ambient lighting level. For example, as shown in FIG. 2, the sensor data 212 includes the ambient light data 212b. In some implementations, the device determines the location by comparing a measured ambient lighting level with ambient lighting levels associated with known locations. For example, the living room may be associated with a first ambient lighting level and the bedroom may be associated with a second ambient lighting level. In this example, the device determines that the device is located in the living room when the measured ambient lighting level matches the first ambient lighting level associated with the living room.

As represented by block 310c, in some implementations, the sensor includes a microphone, the sensor data includes audio data captured by the microphone, and the device determines the location based on the audio data captured by the microphone. For example, as shown in FIG. 2, the sensor data 212 includes the audio data 212c. In some implementations, the device determines the location by comparing the audio data with audio signatures associated with different locations. For example, a home kitchen may be associated with a humming sound of a fridge and a bedroom may be associated with a low-pitched whirling of fan. In this example, the device determines that the device is located in the home kitchen when the audio data matches the humming sound of the fridge.

As represented by block 310d, in some implementations, the sensor includes an inertial measurement unit (IMU), the sensor data includes IMU data, and the device determines the location by determining a change in a previous location based on IMU data captured after a time associated with the previous location. For example, as shown in FIG. 2, the sensor data 212 includes the IMU data 212d. As an example, the device determines an updated location by updating a previously-known location based on an estimated displacement of the device indicated by the IMU data. In some implementations, the sensor includes a magnetometer, the sensor data includes magnetic field data and the device determines the location based on the magnetic field data. For example, referring to FIG. 1B, an area immediately outside the door 32 may be associated with a particular magnetic field measurement and the device 20 determines that the device 20 is outside the door 32 when a measured magnetic field is within an acceptability threshold of the particular magnetic field measurement.

As represented by block 320, in some implementations, the method 300 includes obtaining, via a pose sensor, pose data indicating a pose of the device or a body part of a user of the device. For example, as shown in FIG. 2, the camera activation system 200 obtains the pose data 222 and utilizes the pose data 222 to determine the pose 224 of the device or the user of the device. As represented by block 320a, in some implementations, the pose indicates a head pose of the user. For example, referring to FIG. 1B, the second pose data 44b indicates an orientation of a head of the user 12, for example, that the user 12 is looking downwards towards a position where the door knob 38 is expected to be.

As represented by block 320b, in some implementations, the pose includes a set of one or more angular displacement values of the device or the user from a reference orientation. For example, the pose is defined by a yaw value defining a rotation around a Y axis, a pitch value defining a rotation around an X axis and a roll value defining a rotation around a Z axis. For example, the device pose 224a shown in FIG. 2 includes a set of three angular displacement values.

As represented by block 320c, in some implementations, the pose sensor is integrated in an electronic watch that the user wears around a wrist of the user and the pose includes an orientation of the wrist or an arm of the user. In some implementations, the pose data satisfies a pose criterion when the pose corresponds to a particular gesture such as raising the wrist to a waist level or an eye level of the user. In some implementations, the pose data satisfies the pose criterion when the pose corresponds to a particular activity such as grasping a physical object such as a door knob. In some implementations, the pose indicates an activity of the user (e.g., that the user is dancing).

As represented by block 330, in various implementations, the method 300 includes activating the camera in response to the location satisfying a location criterion and the pose satisfying a pose criterion. For example, as shown in FIG. 1B, the camera activation system 200 turns the camera 22 on in response to determining that the location criterion 52 and the pose criterion 54 have been concurrently satisfied. In some implementations, the method 300 includes maintaining the camera in a deactivated state when the location does not satisfy the location criterion or the pose does not satisfy the pose criterion. For example, as shown in FIG. 1A, the camera activation system 200 provides the maintain instruction 60 to the camera 22 in response to the location criterion 52 and the pose criterion 54 not being satisfied. As described herein, maintaining the camera in an off state until the location criterion and the pose criterion are concurrently satisfied tends to conserve resources, for example, by prolonging a battery of the device and/or reducing memory used by unnecessary image data captured by the camera.

As represented by block 330a, in some implementations, the location criterion is satisfied when the location is within a threshold distance of a physical object that is controllable between a plurality of states. For example, as shown in FIGS. 1A and 1B, the location criterion 52 is satisfied when the first location 42a is within a threshold distance of the door 32. In some implementations, the location criterion is satisfied when the location is among a set of whitelisted locations and the location criterion is not satisfied when the location is among a set of blacklisted locations. As an example, venues such as the venue 70 shown in FIG. 1D may be among whitelisted locations thereby allowing automatic activation of the camera when the pose criterion is satisfied. As another example, secure locations such as security rooms may be among blacklisted locations thereby preventing automatic activation of the camera regardless of the pose.

As represented by block 330b, in some implementations, the pose criterion is satisfied when the pose indicates that the user is looking towards a physical object that is manipulable between a plurality of states. For example, as shown in FIG. 1B, the pose criterion 54 is satisfied when the second pose data 44b indicates that the user 12 is looking down where the door knob 36 is expected to be. In some implementations, the pose criterion is satisfied when a difference between the pose and a previous pose exceeds a threshold. As an example, the pose criterion is satisfied when accelerometer data indicates that the user has turned his/her head. As another example, referring to FIG. 2, the pose criterion 244 is satisfied when a difference between the pose 224 and the previous pose 244c exceeds a threshold.

In some implementations, the pose criterion is not satisfied when a difference between the pose and a previous pose is less than a threshold and the camera captured image data at a time corresponding to the previous pose. In such implementations, the device determines that the user is likely looking at the same physical object that the camera previously captured. As such, the device determines to maintain the camera in the off state in order to conserve battery

In some implementations, the pose criterion is satisfied when the pose is among a set of whitelisted poses and the pose criterion is not satisfied when the pose is among a set of blacklisted poses. As an example, the user may not want to take pictures while lying down. As such, in this example, the pose criterion is not satisfied when the pose data indicates that the user is lying down. As another example, referring to FIG. 2, the pose criterion 244 is satisfied when the pose 224 matches one of the target device orientations 244a or the target body orientations 244b.

As represented by block 330c, in some implementations, the method 300 includes obtaining state data indicating a current state of a controllable physical object within a proximity threshold of the location of the device, and activating the camera in response to the current state matching a threshold state. For example, referring to FIG. 1C, the camera activation system 200 obtains the lock unlocked indication 64 and does not turn on the camera 22 even though the location criterion 52 and the pose criterion 54 are satisfied because the lock 36 is already unlocked and there is no need to confirm that the user 12 is at the door 32 in order to unlock the lock 36.

As represented by block 330d, in some implementations, the method 300 includes activating the camera in response to a gaze input satisfying a gaze criterion. As an example, if a gaze duration exceeds a threshold time, the device determines that the user is likely looking at a physical object that is of interest and wants to capture an image of the physical object or control the physical object using gestures. As such, in this example, the device turns on the camera in order to confirm that the user is within a threshold distance of the object. For example, as described in relation to FIG. 2, the camera activator 230 provides the activate instruction 232 based on the gaze data 212e satisfying a gaze criterion in addition to the location criterion 242 and the pose criterion 244 being satisfied. In some implementations, the method 300 includes obtaining the gaze input via an eye tracker that is different from the camera. For example, the device receives the gaze data from a user-facing camera that is different from a scene-facing camera or an outward-facing camera that the camera activation system 200 controls.

As represented by block 330e, in some implementations, the method 300 includes playing a sound effect when the camera is activated and the camera is directed to a person that is not looking towards the camera, and forgo playing the sound effect when the person is looking towards the camera. In some implementations, playing the sound effect provides an indication to the user that the camera has automatically been turned on thereby providing the user an option to turn the camera off.

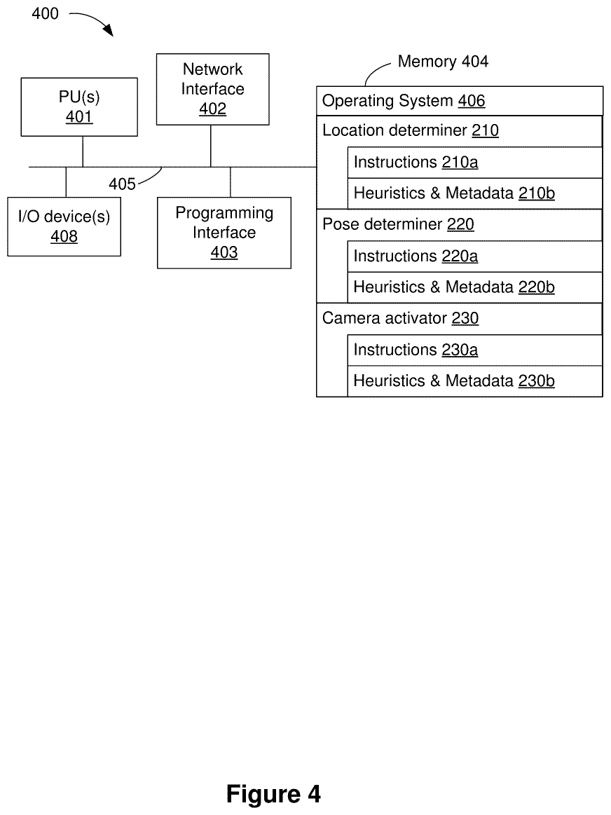

FIG. 4 is a block diagram of a device 400 in accordance with some implementations. In some implementations, the device 400 implements the device 20 shown in FIGS. 1A-2 and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the location determiner 210, the pose determiner 220 and the camera activator 230. In various implementations, the device 400 performs the method 300 shown in FIG. 3.

In some implementations, the location determiner 210 includes instructions 210a, and heuristics and metadata 210b for determining a location of the device 400 (e.g., the location 214 shown in FIG. 2). In some implementations, the location determiner 210 performs at least some of the operation(s) represented by block 310 in FIG. 3.

In some implementations, the pose determiner 220 includes instructions 220a, and heuristics and metadata 220b for determining a pose of the device 400 or a user of the device 400 (e.g., the pose 224 shown in FIG. 2). In some implementations, the pose determiner 220 performs at least some of the operation(s) represented by block 320 in FIG. 3.

In some implementations, the camera activator 230 includes instructions 230a, and heuristics and metadata 230b for automatically activating a camera of the device 400 in response to the location satisfying a location criterion and the pose satisfying a pose criterion. In some implementations, the camera activator 230 performs at least some of the operation(s) represented by block 330 in FIG. 3.

In some implementations, the one or more I/O devices 408 include a set of one or more sensors for capturing sensor data (e.g., the sensor data 212 shown in FIG. 2). For example, the one or more I/O devices 408 include a location sensor for capturing the location data 212a, an ALS for capturing the ambient light data 212b, a microphone for capturing the audio data 212c, an IMU for capturing the IMU data 212d and/or an eye tracker for capturing the gaze data 212e shown in FIG. 2. In some implementations, the one or more I/O devices 408 include a pose sensor for capturing the pose data 222 shown in FIG. 2. In some implementations, the one or more I/O devices 408 include a receiver for receiving the sensor data 212 and/or the pose data 222 from another device. In some implementations, the one or more I/O devices 408 include an image sensor (e.g., a visible light camera, for example, the camera 22 shown in FIGS. 1A-1E) that is being automatically controlled (e.g., automatically switched between an active state and an inactive state, for example, automatically switched between an on state and an off state) by the camera activator 230.

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a camera, a sensor, one or more processors and a non-transitory memory:
obtaining, via the sensor, sensor data indicative of a location of the device;
obtaining, via a pose sensor, pose data indicating a pose of the device or a body part of a user of the device; and
activating the camera in response to the location satisfying a location criterion and the pose satisfying a pose criterion.

2. The method of claim 1, further comprising maintaining the camera in a deactivated state when the location does not satisfy the location criterion and the pose does not satisfy the pose criterion.

3. The method of claim 1, wherein the location criterion is satisfied when the location is within a threshold distance of a physical object that is controllable between a plurality of states.

4. The method of claim 1, wherein the pose criterion is satisfied when the pose indicates that the user is looking towards a physical object that is manipulable between a plurality of states.

5. The method of claim 1, wherein the pose criterion is satisfied when a difference between the pose and a previous pose exceeds a threshold.

6. The method of claim 1, wherein the pose criterion is not satisfied when a difference between the pose and a previous pose is less than a threshold and the camera captured image data at a time corresponding to the previous pose.

7. The method of claim 1, further comprising:
obtaining state data indicating a current state of a controllable physical object within a proximity threshold of the location of the device; and
activating the camera in response to the current state matching a threshold state.

8. The method of claim 1, further comprising:
activating the camera in response to a gaze input satisfying a gaze criterion.

9. The method of claim 8, further comprising obtaining the gaze input via an eye tracker that is different from the camera.

10. The method of claim 1, further comprising:
playing a sound effect when the camera is activated and the camera is directed to a person that is not looking towards the camera; and
forgo playing the sound effect when the person is looking towards the camera.

11. The method of claim 1, wherein the sensor includes a location sensor and the sensor data includes location data captured by the location sensor.

12. The method of claim 1, wherein the sensor includes a receiver that receives location data from another device including a location sensor that captured the location data.

13. The method of claim 1, wherein the sensor includes an ambient light sensor (ALS), the sensor data includes an ambient lighting level captured by the ALS, and the device determines the location based on the ambient lighting level.

14. The method of claim 1, wherein the sensor includes a microphone, the sensor data includes audio data captured by the microphone, and the device determines the location based on the audio data captured by the microphone.

15. The method of claim 1, wherein the sensor includes an inertial measurement unit (IMU), the sensor data includes IMU data, and the device determines the location by determining a change in a previous location based on IMU data captured after a time associated with the previous location.

16. The method of claim 1, wherein the sensor includes a magnetometer, the sensor data includes magnetic field data and the device determines the location based on the magnetic field data.

17. The method of claim 1, wherein the pose indicates a head pose of the user.

18. The method of claim 1, wherein the pose sensor is integrated in an electronic watch that the user is wearing around a wrist of the user and the pose includes an orientation of the wrist or an arm of the user.

19. A device comprising:
a camera;
a sensor;
a non-transitory memory; and
one or more processors to:
obtain, via the sensor, sensor data indicative of a location of the device;
obtain, via a pose sensor, pose data indicating a pose of the device or a body part of a user of the device; and
activate the camera in response to the location satisfying a location criterion and the pose satisfying a pose criterion.

20. A non-transitory memory storing one or more programs, which, when executed by one or more processors of a device including a camera and a sensor, cause the device to:
obtain, via the sensor, sensor data indicative of a location of the device;
obtain, via a pose sensor, pose data indicating a pose of the device or a body part of a user of the device; and
activate the camera in response to the location satisfying a location criterion and the pose satisfying a pose criterion.
